(19) United States
(12) Patent Application Publication
(10) Pub. No.: US 2026/0186119 A1
(43) Pub. Date: Jul. 2, 2026

(54) HIGH RESOLUTION DISTANCE ESTIMATION USING SPATIALLY DIVERSE SIGNALS

(71) Applicant: Google LLC, Mountain View, CA (US)

(72) Inventors: Chin-Wei Hsu, Sunnyvale, CA (US); Li-Xuan Chuo, San Jose, CA (US); Qi Jiang, San Jose, CA (US); Daniel Jose Fernandes Barros, Mountain View, CA (US)

(21) Appl. No.: 19/131,773

(22) PCT Filed: Dec. 16, 2022
(86) PCT No.: PCT/US2022/081742

§ 371 Date: May 21, 2025

(51) Int. Cl. G01S 11/06; G07C 9/00; H04B 7/08

(52) U.S. Cl. CPC G01S 11/06; G07C 9/00309; H04B 7/0885; G07C 2009/00769; G07C 2209/61

(57) ABSTRACT

The disclosure relates to apparatuses, systems, and techniques for using a plurality of antennas and a signal processor configured to receive a plurality of received components of a signal and combine the signals into a single combined frequency domain signal and based on the single combined frequency domain signal, determine an estimated distance between a device and another device, and perform an action.

### BACKGROUND

Wireless devices may use radio frequency (RF) signals to transfer data between each other. In transferring data, a first wireless device may transmit an RF signal using a radio transmitter, being the transmitting device. A second wireless device may receive the RF signal using a radio receiver, being the receiving device. The RF signal transmitted by the transmitting device may propagate into the surrounding space, reflecting off various conductive and dielectric surfaces. These reflections may cause a multipath fading effect, where multiple copies of the same signal are received by the receiving device at different intervals in time. These multipath effects may add complexity to various calculations, such as those based on signal propagation time.

### SUMMARY

In general, this disclosure is directed to wireless devices and techniques for determining a distance estimation between two wireless devices (e.g., in the presence of multipath fading). To estimate the distance between two wireless devices, a first wireless device may be configured as a receiving device and the second wireless device may be configured as a transmitting device. A receiving device may transform a received frequency domain signal into a time domain signal, determine a time delay from the time domain signal, and determine a distance based on the time delay. However, various signal propagation phenomena, such as multipath fading, may adversely impact accuracy of such a technique. In some examples, the receiving device may utilize several spatially diverse antennas to obtain spatially diverse copies of the received signal. For instance, a receiving device may separately process frequency domain signals from spatially diverse antennas to generate several distance estimations and utilize a shortest of the distance estimations as the final estimated distance. However, this may present one or more disadvantages, such as the increased system resource consumption of duplicative processing.

In accordance with one or more techniques of this disclosure, a receiving device may combine frequency domain signals from multiple antennas and determine the distance based on the combined signal. For instance, the receiving device may receive a plurality of received components of a signal from a transmitting device, convert each of the components into a frequency domain signal, combine the frequency domain signals to generate a combined frequency domain signal, transform the combined frequency domain signal into a combined time domain signal, and determine the distance based on the combined time domain signal. In this way, the techniques of this disclosure enable a reduction in system resources (e.g., power) consumed to perform distance estimation and/or enable an improvement in distance estimation accuracy.

In one example, various techniques may include receiving, from a plurality of antennas of a receiving device, a plurality of received components of a signal from a transmitting device; converting each received component of the plurality of received components into a frequency domain signal of a plurality of frequency domain signals; combining, by the receiving device, the plurality of frequency domain signals into a single combined frequency domain signal; determining, by the receiving device and based on the single combined frequency domain signal, an estimated distance between the receiving device and a transmitting device; and performing, by the receiving device and based on the estimated distance, an action.

In another example, a device may include a plurality of antennas; a receiver configured to receive, via the plurality of antennas, a plurality of frequency domain signals from; a processor programed to combine the plurality of frequency domain signals into a single combined frequency domain signal; determine, based on the single combined frequency domain signal, an estimated distance between the device and another device; and perform, based on the estimated distance, an action.

This summary is intended to provide an overview of the subject matter described in this disclosure. It is not intended to provide an exclusive or exhaustive explanation of the apparatus and methods described in detail within the accompanying drawings and description below. Further details of one or more examples are set forth in the accompanying drawings and the description below.

### BRIEF DESCRIPTION OF DRAWINGS

FIG. 1 is a conceptual drawing illustrating an example of a receiving device configured to receive components of a transmitted signal from a transmitting device in the presence of multipath, in accordance with one or more techniques of this disclosure.

FIG. 2 is a conceptual block diagram illustrating an example of a receiving device configured to receive components of a transmitted signal and estimate the distance to a transmitting device, in accordance with one or more techniques of this disclosure.

FIG. 3 is a conceptual block diagram illustrating an example of a signal combiner configured to process a plurality frequency domain signals and combine them into a single combined frequency domain signal, in accordance with the disclosure.

FIG. 4 is a conceptual block diagram illustrating an example of signal processing techniques implemented with a circular convolution operator, in accordance with the disclosure.

FIG. 5 is a conceptual graph illustrating a signal magnitude plot of a first frequency domain signal transformed into the time domain, in accordance with one or more techniques of this disclosure.

FIG. 6 is a conceptual graph illustrating a signal magnitude plot of a second frequency domain signal transformed into the time domain, in accordance with one or more techniques of this disclosure.

FIG. 7 is a conceptual graph illustrating a signal magnitude plot of a first frequency domain signal received by a first antenna, in accordance with one or more techniques of this disclosure.

FIG. 8 is a conceptual graph illustrating a power magnitude plot of a second frequency domain signal received by a second antenna, in accordance with one or more techniques of this disclosure.

FIG. 9 is a conceptual graph illustrating a signal magnitude plot of a single combined frequency domain signal representing the combination of the first frequency domain signal and the second frequency domain signal, in accordance with one or more techniques of the disclosure.

FIG. 10 is a conceptual graph illustrating a signal magnitude plot of a time domain signal representation of the single combined frequency domain signal, in accordance with one or more techniques of the disclosure.

FIG. 11 is a conceptual graph illustrating the empirical cumulative distribution function (ECDF) representing signal quality for a variety of signal combination techniques with an average received signal to noise ratio (SNR), in accordance with one or more techniques of this disclosure.

FIG. 12 is a conceptual graph illustrating the ECDF representing signal quality for a variety of signal combination techniques in the presence of low SNR signals, in accordance with one or more techniques of this disclosure.

FIG. 13 is a conceptual flow chart illustrating an example of a method for estimating a distance between a receiving device and a transmitting device, in accordance with one or more techniques of the disclosure.

### DETAILED DESCRIPTION

A wireless device may be a device that transmits and receives data via a radio frequency (RF) link. In some examples, the wireless device may communicate with another wireless device. In some examples, a plurality of wireless devices may exchange information using multicast communication. The two or more wireless devices may communicate data between pairs of wireless devices or from one wireless device to a plurality of wireless devices. Some examples of wireless devices may include cellular telephones, laptops, smart watches, smart appliances, or other digital devices that utilize RF for communication.

In some examples, determining a physical distance of separation between one or more devices may be useful for a variety of applications. In some examples, knowing a wireless device is within a certain range of another wireless device may be used to turn-on, unlock, or initiate a program on one of the wireless devices. In some examples, knowing the distance between a wireless device and another wireless device may help one find one of the wireless devices by indicating the user the distance between two devices.

However, determining a distance between two wireless devices may be challenging in indoor environments. Wireless devices, such as computers, mobile devices, and smart watches are oftentimes used in indoor environments. Indoor environments may pose additional challenges to wireless communication given the confined physical spaces often present in indoor environments. In some examples, metal shelves, walls, tables, ceilings, floors, and other objects may cause electromagnetic signals to reflect, generating multipath interference for the two wireless devices. The techniques disclosed address one or more of these challenges, resulting in a more accurate and consistent distance estimate than other techniques.

In some examples, a first of the two wireless devices may be configured as a transmitting device and a second of the two wireless devices may be configured as a receiving device. The transmitting device may send, transmit, broadcast, initiate, a wireless signal that may be received, input, captured, or picked-up by the receiving device.

While not required, in some examples, the transmitting device may use a clock synchronized with the receiving device. The synchronized clocks may be used to maintain consistent timing. While not required, in some examples, a wireless device may use its internal clock to assist in directly processing and organizing communications. A first clock of a transmitting device may be considered synchronized with a second clock of a receiving device when the approximate time on one of the two clocks corresponds with the time of the other clock.

In some examples, a transmitting device having a first clock synchronized with a second clock of a receiving device, may also use RF signals in combination with their synchronized clocks to estimate a signal propagation time delay between two wireless devices. A receiving device may estimate a one-way signal propagation time delay, beginning from the time it takes from a signal sent by the transmitting device to be received by the receiving device. The transmitting device may time stamp a signal right before sending it to a receiving device. A time stamp may be a piece of information indicating the time at which the transmitting device sent the signal. The time stamp is specified based on the synchronized clock time. The receiving device may receive the time stamped signal and determine the send time at which the transmitting device sent the signal. The receiving device may compare the send time to its internal clock value at the time the receiving device received the message.

In some examples, the receiving device may use RF signals in combination with its synchronized clock to estimate a signal propagation time delay between itself and a transmitting device. In particular, a receiving device may estimate a signal propagation time delay from a signal sent by a transmitting device. The transmitting device may time stamp a signal right before sending it to a receiving device. A time stamp may be a piece of information indicating the time at which the transmitting device sent the signal. The time stamp is specified based on the synchronized clock time. The receiving device may receive the time stamped signal and determine the send time at which the transmitting device sent the signal. The receiving device may compare the send time to its internal clock value at the time the receiving device received the message.

In some examples, an internal clock of a transmitting device may be unsynchronized with a receiving device. A phase of the received signal may be compared with the phase of an internal reference within the receiving device. Based on a difference in phase between the signal and the reference, a propagation time may be estimated.

In some examples, a first receiving device may be configured to transmit a first signal to a transmitting device configured to receive the first signal. The transmitting device may process the first signal and accurately preserve the phase of the received signal. The transmitting device may be reconfigured to transmit, and the receiving device may be reconfigured to receive. The transmitting device may transmit a second signal, being a copy of the received signal with the preserved phase, to the receiving device. The receiving device may receive the second signal and compare the phase of the second signal to the phase of the internal reference. Based on the difference in phase between the receive signal and the reference, a two-way propagation time delay may be determined. Dividing the two-way propagation delay by two, the receiving device may determine a one-way propagation time delay between itself and the transmitting device.

The one-way signal propagation time delay between the transmitting device and the receiving device, may be multiplied by the speed of light to get a distance (e.g., line-of-sight). Multipath environments may make propagation time delay estimates, and therefore distance estimates, difficult. Multipath environments are environments where an RF signal is likely to encounter many metallic or electromagnetically reflective surfaces while propagating from a transmitting device to a receiving device. Such reflective surfaces may include surfaces on large electrically conductive or high dielectric objects or materials. Indoor office spaces, homes, and other tightly enclosed spaces may generate high levels of multipath while using common wireless communication frequencies (e.g., 2.4 GHz and 5.8 GHz).

In some examples, receiving devices may utilize a plurality of antennas to improve signal detection in multipath environments. Each signal received by an antenna may be compared with the signals received by each of the other antennas of the plurality. In one example, the lowest time value corresponding to a peak in the signal value may be used as an approximate signal propagation time delay and may represent the line-of-sight distance, which is the minimal distance between a transmitting device and a receiving device.

Multipath fading may affect the power level of a receiving device, based on the location and orientation of the transmitting device. Fading results from the constructive and/or destructive interferences of reflected signal components combined by the receiving device at about the same time. In some examples, fading effects can be so significant that received signal power levels of signal components may be greater than the received signal power level of the line-of-sight signal. In some examples, the power level of the line-of-sight signal I may not be observed above a noise threshold, while a received signal component of the transmitted signal, may exceed the noise threshold. The fading effect may result in errors to delay time estimates when techniques exclusively utilize a power threshold comparison. Errors in delay time estimates, thereby result in distance estimation errors.

The techniques of this disclosure may more accurately estimate a signal propagation time delay between a transmitting device and a receiving device in the presence of a strong multipath environment. A more accurate signal propagation time delay will result in a more accurate distance estimate. The techniques of the disclosure utilize a plurality of spatially diverse antennas on a receiving device to receive a plurality of spatially diverse multipath signals. The receiving device may combine the plurality of spatially diverse frequency domain signals, generating a combined frequency domain signal. The receiving device may transform the frequency domain signal into a time domain signal and use a threshold value to determine whether a local peak is present across a portion of frequency bandwidth. In some examples, a time domain signal exceeding a threshold value, may indicate that the receiving device may attempt to use a peak detection calculation. In some examples, a time domain signal exceeding a threshold value and indicating a peak has been detected by the peak detection calculation, may indicate a possible line-of-sight signal. Using the smallest corresponding time delay, the receiving device may accurately estimate a distance, the physical linear separation between the receiving device and the transmitting device. The estimation may be used to initiate an action, such as electrically unlocking, or logging into either the transmitting device or the receiving device.

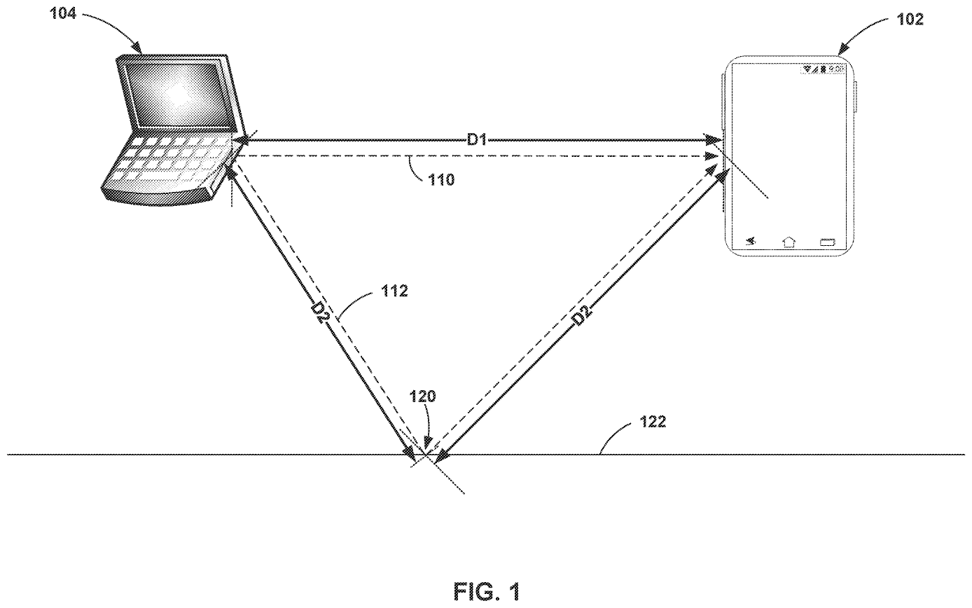

FIG. 1 is a conceptual drawing illustrating an example of a receiving device configured to receive components of a transmitted signal from a transmitting device in the presence of multipath, in accordance with one or more techniques of this disclosure.

In some examples, a wireless device such as a receiving device 102 may be configured to estimate a distance, or physical linear separation, between itself and transmitting device 104. In some examples, transmitting device 104 and/or receiving device 102 may include multiple antennas to wirelessly receive line-of-sight signal 110 using a plurality of antennas.

Receiving device 102 may receive line-of-sight signal 110, which is a signal received after traveling a straight line from a transmitting device 104 to a receiving device 102. Receiving device 102 may also receive a component 112 of the signal, which is a reflected signal of the same transmitted signal from transmitting device 104.

In order for receiving device 102 to receive a signal, transmitting device 104 may transmit an electromagnetic signal. The electromagnetic signal may be sent on a commonly used industrial, scientific and medical (ISM) communication frequency. Commonly used ISM frequencies (e.g., 2.4 GHz or 5.8Ghz) may be used with a suitable known standardized communication protocol (e.g., Wi-Fi or Bluetooth) or with a proprietary protocol. The transmitting device 104 may send an electromagnetic signal with a time stamp to receiving device 102. In some examples, transmitting device 104 may transmit the signal with a single antenna, the antenna may be omnidirectional, causing the electromagnetic signal to propagate in a wide angle. The propagating signal may travel as a plurality of components traveling along a plurality of paths to receiving device 102, such that the signal is “multipath”.

The signal component traveling along the line-of-sight path between transmitting device 104 and receiving device 102 is the desired signal to use for a time-of-flight measurement. An accurate estimate of the propagation time delay of line-of-sight signal 110 may be used to determine the line-of-sight distance D1, which is the linear separation between receiving device 102 and transmitting device 104. High Accuracy Distance Measurement (HADM) over Bluetooth™ wireless is an example of a technique being developed to measure the distance between objects. Methods are also known that employ ultra-wideband (UWB) signals to measure distance between devices. These and other techniques are known for measuring time-of-flight. However, in a multipath environment, multiple components of the same transmitted signal are received by the receiving device at different times due to multipath propagation. Component 112 takes longer to reach receiving device 102 than line-of-sight signal 110 due to traveling a longer, reflection flight path. The additional path length of reflected distance D2 as compared to line-of-sight distance D1 will depend on the number of reflections and the distance that the reflective surfaces are from line-of-sight signal 110 path.

A reflection 120 may result from a propagation path of an electromagnetic signal impinging on an electrically large surface that is electromagnetically reflective. Many surfaces are known to cause reflections, such as building walls and large metal objects. The time delays experienced by signal components traveling along the reflected paths will vary due to the number of reflections of the signal and the electrical path length between the reflections. In addition to the time delay, the power levels at which receiving device 102 receives these various signals may vary due to multipath fading effects and multipath interference. Multipath interference is a phenomenon in which a wave from a source, travels to the receiver via multipaths and components from the different paths of that wave interfere constructively and/or destructively.

In some examples, the receiving device may convert each component of the plurality of received components into a frequency domain signal of a plurality of frequency domain signals. Converting each component may taking samples of the received component over time with an analog to digital converter. The samples taken over time may represent samples of a time domain signal. The samples representing the time domain signal may be converted to samples representing a frequency domain signal using fast Fourier transform techniques.

Receiving device 102 may utilize a plurality of antennas to receive signals that include line-of-sight signal 110 and reflected signals. Each antenna in the plurality of antennas is spaced from the other antennas of the plurality, advantageously diversifying the plurality of antennas. In some examples, two antennas may be considered to be spatially diverse when a power profile received via a first of the two antennas is independent of a power profile received via a second of the two antennas of the multipath channel. The plurality of spatially diverse antennas may be configured to receive a plurality of frequency domain signals.

In some examples, receiving device 102 may combine, by the device, the plurality of frequency domain signals into a single combined frequency domain signal as will be described herein. As noted above, it may be desirable for a device, such as receiving device 102, to determine a distance to a wireless device, such as transmitting device 104. In some examples, determining, by the device and based on the single combined frequency domain signal, an estimated distance between the device and another device. For instance, receiving device 102 may be configured to perform an action responsive to determining that a distance between receiving device 102 and transmitting device 104 is less than a distance threshold. Or transmitting device 104 may want to locate devices within a certain distance, so the receiving device 102 may send the distance measurement to transmitting device 104. To accomplish this, as noted above, receiving device 102 may be configured, in accordance with one or more techniques of this disclosure, to receive line-of-sight signal 110 and component 112 from transmitting device 104 and estimate the line-of-sight distance.

A receiver, configured to receive the signals on the plurality of antennas, may generate a plurality of frequency domain signals. In some examples, the plurality of antennas used to receive signals by the receiver may operate in conjunction with a second plurality of antennas used by transmitting device 104. Each frequency domain signal, in the plurality of frequency domain signals, represents a signal uniquely processed from a received component on an antenna of the plurality of antennas. In some examples, receiving device 102 may be configured to combine the plurality of frequency domain signals, generated by the receiver, into a combined frequency domain signal. The receiving device 102 may also be configured to transform the combined frequency domain signal into a time domain signal. Using threshold detection and peak detection methods, receiving device 102 may be configured to estimate a distance corresponding to the line-of-sight distance D1.

In some examples, receiving device 102 may be configured to perform, by the device and based on the estimated distance, an action. In some examples, the action may be to unlock, login, turn on, or other wireless digital opening feature. In some examples, the action may be to transmit data representing the estimated distance.

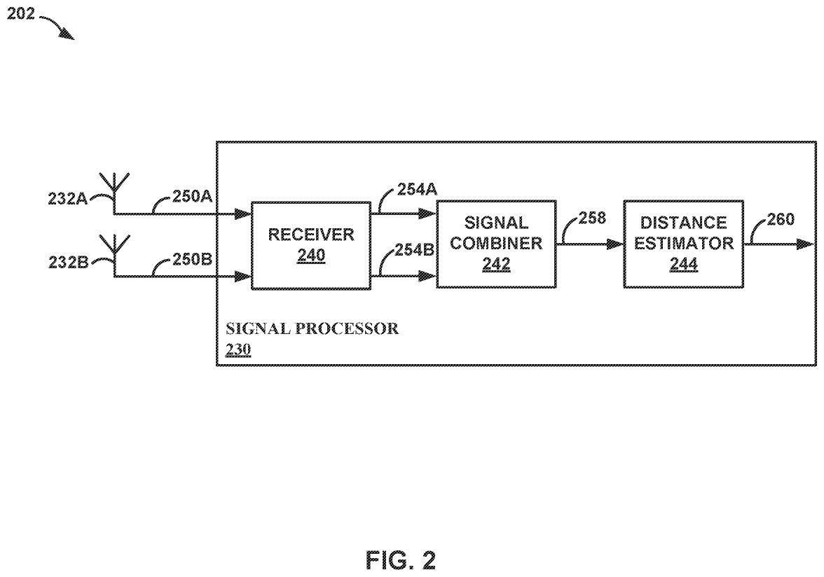

FIG. 2 is a conceptual block diagram illustrating an example of a receiving device configured to receive components of a transmitted signal and estimate the distance to a transmitting device, in accordance with one or more techniques of this disclosure. Wireless device 202 of FIG. 2 may be an example of receiving device 102 of FIG. 1. As shown in FIG. 2, wireless device 202 may include a plurality of antennas 232A and 232B (collectively, “antennas 232”), and a signal processor 230.

Antennas 232 may be configured to receive a plurality of wireless signals (e.g., frequency domain signals) sent by another wireless device. Antennas 232 may output representations of the received wireless signals to another component of device 202 (e.g., receiver 240). In some examples, each of the plurality of frequency domain signals represents a unique signal received by an antenna of antennas 232. For instance, first frequency domain signal 254A may be a unique signal received by antenna 232A and second frequency domain signal 254B may be a unique signal received by antenna 232B. While illustrated as including two antennas, antennas 232 are not be so limited. In some examples, antennas 232 may include 2, 3, 4, 5, 6, 7, 8, etc. antennas.

Signal processor 230 may be configured to receive the representations of the wireless signals from antennas 232 and estimate, based on the wireless signals, a distance to another wireless device. As shown in FIG. 2, signal processor 230 may include a receiver 240, a signal combiner 242, and a distance estimator 244.

Antennas 232 may include spatially diverse antennas. In some examples, spatially diverse antennas may include two or more antennas configured to be spatial diverse from one another. In some examples, antennas 232 may include a variety of antenna elements collocated on a single printed circuit board (PCB) or integrated circuit (IC) package. In some examples, first antenna 232A of antennas 232 and second antenna 232B of antennas 232 may be configured to receive an RF signal over the same frequency band. In various examples, first antenna 232A, being spatially diverse from second antenna 232B, may receive a first power profile from the multipath channel that is independent from a second power profile received by second antenna 232B from the multipath channel. Each antenna of the plurality of antennas, may receive noise signals simultaneously with the signal power profile. The noise signals and signal power profile may be sent as inputs to receiver 240 via a transmission line. Receiver 240 may receive the signal power and noise signals and produce a plurality of frequency domain signals (e.g., first frequency domain signal 254A, and second frequency domain signal 254A).

As noted above, antennas 232 may output representations of received signals to other components. For instance, each antenna of antennas 232 may output a respective frequency domain signal of first frequency domain signal 250A and second frequency domain signal 250B (collectively, “frequency domain signals 250”) to receiver 240. As shown in FIG. 2, first antenna 232A may output first frequency domain signal 250A to receiver 240 and second antenna 232B may output second frequency domain signal 250B to receiver 240.

In some examples, signal processor 230 may include a single IC or a plurality of IC's arranged within a package. In some examples, a package may be an IC package, a PCB, or other circuit medium. In some examples, signal processor 230 may implement receiver 240, signal combiner 242, and distance estimator 244 as firmware, hardware, or a combination thereof. In some examples, signal processor may include additional function blocks apart from receiver 240, signal combiner 242, and distance estimator 244. In some examples, the techniques performed by signal processor 230 may be combined within a single functional firmware block, version, or instance.

In some examples, receiver 240, implemented on signal processor 230, may receive the plurality of frequency domain signals 250. For instance, receiver 240 may receive first frequency domain signal 250A and second frequency domain signal 250B. Switching between shared hardware, or utilizing separate hardware in parallel, receiver 240 may process frequency domain signals 250 to generate corresponding digital frequency domain signals 254A and 254B (collectively, “digital frequency domain signals 254”). For instance, receiver 240 may digitize first frequency domain signal 250A to generate first digital frequency domain signal 254A and digitize second frequency domain signal 250B to generate second digital frequency domain signal 254B. Receiver 240 may output the digital signals to one or more other components of signal processor 230, such as signal combiner 242.

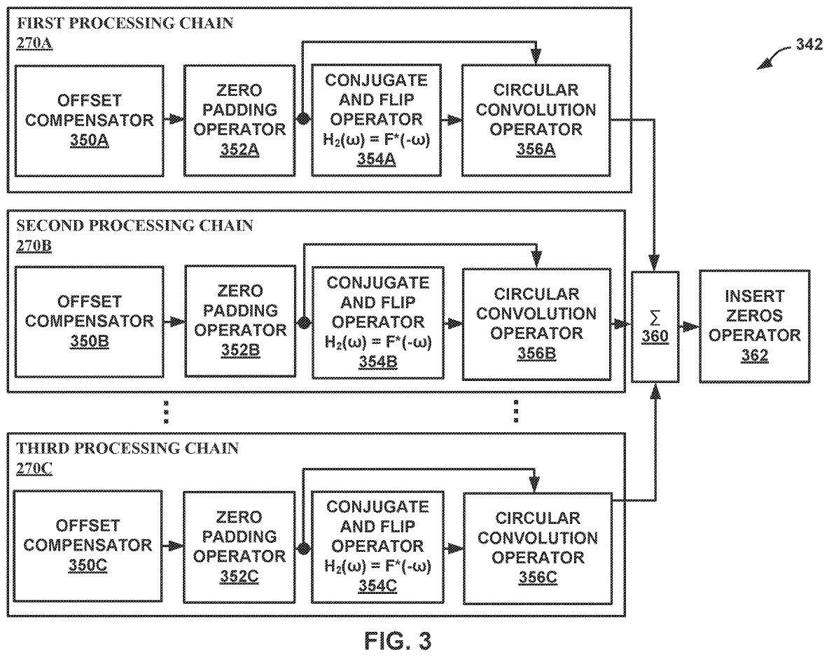

In accordance with one or more aspects of this disclosure, signal combiner 242 may be configured to combine the plurality of frequency domain signals into a single combined frequency domain signal. For instance, signal combiner 242 may combine digital frequency domain signals 254 into a single combined frequency domain signal 258. Signal combiner 242 may combine the plurality of frequency domain signals in a variety of ways. As one example, signal combiner 242 may transform the frequency domain signals into time domain signals, combine the signals in the time domain, and transform the combined time domain signal back into the frequency domain. Further details of one example of signal combiner 242 are discussed below with reference to FIG. 3. Signal combiner 242 may output the combined frequency domain signal to one or more other components of device 202, such as distance estimator 244.

Distance estimator 244 may be configured to estimate a distance between device 202 and another device. For instance, distance estimator 244 may determine, based on single combined frequency domain signal 258, an estimated distance 260 between device 202 and another device (e.g., device 104 of FIG. 1). In some examples, single combined frequency domain signal 258 may be input to distance estimator 244. Distance estimator 244 may perform an IFFT on combined frequency domain signal 258 to produce a signal combined time domain signal. In some examples, estimated distance 260 may be an estimate of the physical line of site separation (e.g., displacement) between a transmitting wireless device and a receiving wireless device. In some examples, distance estimator 244 may calculate the distance based on the time dependent elements found within single combined frequency domain signal 258. In some examples, distance estimator 244 may determine estimated distance 260 by at least inverse fast Fourier transforming the combined frequency domain signal to generate a combined time domain signal, identifying a time value corresponding to a signal peak in the combined time domain signal, and calculating the estimated distance based on the time value.

In some examples, performing an IFFT may be done by an IFFT within in distance estimator 244. An input to distance estimator 244 may be single combined frequency domain signal 258, represented as a first data series. The output of the IFFT operator may be the single combined time domain signal represented as a second data series.

In some examples, identifying a time value may include a variety of techniques. In some examples, identifying a time value may include identifying, within the combined time domain signal, one or more signal portions having amplitudes that exceed a threshold value. In some examples, identifying a time value may identifying, for each respective signal portion of the one or more signal portions, a respective peak of one or more peaks. In some examples, identifying a time value may determining, for each respective peak of the one or more peaks, a respective time value of a plurality of time values. In some examples, identifying a time value may include selecting a smallest time value of the plurality of time values as the time value. For instance, using the speed of light as an approximate speed for the wireless signal, distance estimator 244 may translate time dependent elements of single combined frequency domain signal 258 into estimated distance 260. Distance estimator 244 may use additional propagation factors to generate estimated distance 260. In some examples, additional propagation factors may include one or more of dielectric value, conductivity factor, dispersion value, refraction index, and other environmental electromagnetic factors.

FIG. 3 is a conceptual block diagram illustrating an example of a signal combiner configured to process a plurality of frequency domain signals and combine them into a single combined frequency domain signal, in accordance with the disclosure. Signal combiner 342 may be an example of signal combiner 242 of FIG. 2. In some examples, a plurality of processing chains, first processing 270A, second processing 270B, and third processing chain 270C (collectively, “processing chains 270”) may receive a plurality of spatially diverse frequency domain signals 254., The processing chains 270 may generate a plurality of processed frequency domain signals. The signal combiner 342 may combine the plurality of processed frequency domain signals into a single time domain signal. Signal combiner 342 may combine the outputs from processing chains 270 with sum operator 360. The output of sum operator 360 may be processed by an insert zeros operator 362. In some examples, each processing chain of processing chains 270 may compensate a respective frequency domain signal of the plurality of frequency domain signals. Compensating a frequency domain signal may include signal multiplying the frequency domain signal by a complex value or function.

In some examples, the compensation factors may correspond to phase delays, phase shifts, or time delays depending on the domain of the signal. Each frequency domain signal within each processing chain of processing chains 270, may be signal multiplied by a compensation factor. Signal multiplying the signal by the compensation factor may phase shift, phase delay, and/or time delay the signal. A time delay in the time domain corresponds to a signal multiplication by a complex natural exponential value. Signal multiplying each frequency domain signal by a unique complex natural exponential value will phase shift or phase delay each frequency domain signal by a unique value. A compensation factor may be chosen to improve signal levels of the combined frequency domain signal. In some examples, improving a signal level of the combined frequency domain signal depends on selecting compensation factors to offset natural process variation between each processing chain (e.g., first processing chain 270, second processing chain 270B, and third processing chain 270C).

In some examples, the plurality of processing chains may perform a circular convolution on each compensated signal, of the plurality of compensated signals, to generate a plurality of convolved compensated signals. Each convolved compensated signal of the plurality of convolved compensated signals may correspond to a compensated signal of the plurality of compensated signals. In some examples, the outputs of processing chains 270 may be summed together by summation to generate a combined frequency domain signal.

Each chain in the plurality of processing chains may include a variety of signal processing techniques. Each signal processing technique may be implemented as signal processing code implemented on a signal processor. Some signal processing techniques included in each chain may include an offset compensator 350, a zero padding operator 352, a conjugate and flip operator 354, and a circular convolution 356. The plurality of frequency domain signals, processed by the processing chains 270 may be combined into a combined frequency domain signal with sum operator 360 and insert zeros operator 362.

In some examples, a wireless device may be configured to use a processor to implement one or more techniques of this disclosure. In some examples, functions described by the central processor may be implemented in hardware, software, firmware, or any combination thereof. If implemented in software, the functions of the central processor may be stored on, or transmitted over, one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

In some examples, each processing chain in the plurality of processing chains may include offset compensator 350. Offset compensator 350 may include signal processing code implemented on a processor configured to compensate a particular frequency domain signal of the plurality of frequency domain signals. In some examples, compensating a particular frequency domain signal of the plurality of frequency domain signals may include determining, based on a calibration time delay between a first antenna and a second antenna of the plurality of antennas, the respective compensation factor for the particular frequency domain signal. In some examples, compensating a particular frequency domain signal of the plurality of frequency domain signals may include adjusting, based on the respective compensation factor, the particular frequency domain signal to generate a corresponding compensated signal of the plurality of compensated signals.

In some examples, the frequency domain signal may be represented as a series of data further representing complex digital numbers. The complex digital numbers may represent the frequency domain signal by defining sample data converted to the frequency domain. In some examples, offsetting a frequency domain signal may include multiplying the frequency domain signal by a complex number or plurality of complex numbers. The multiplication of the frequency domain signal by a plurality of complex number may be equivalent to time delaying an equivalent time domain signal.

In some examples, zero padding operator 352 may include extending the series of data by adding zero values. Using a plurality of zero padding operators, each compensated signal of the plurality of compensated signals may be padded with zero values for a portion of time at a beginning of the signal and at an end for the signal to generate a plurality of padded signals.

The series of data with added zero values may be run through an IFFT. A long series of data may allow for an IFFT with more points, resulting in an IFFT with finer resolution. Adding zero values to the end of the series of data before performing an IFFT may result in a spreading of the signal over a resulting time domain. In some examples, the number of zero values to be added to the series of the data may depend on the number of points used in the IFFT, determined by the desired signal resolution and processing resources available. In some examples, zero values may be added to the end of the series of data. In some examples, a copy of the zero padded frequency domain signal may be sent to conjugate and flip operator 354 (e.g., an operator using an IFFT and an FFT). In some examples, a copy of the zero padded frequency domain signal may be sent to circular convolution 356.

In some examples, conjugate and flip operator 354 technique may be a signal processing technique that includes reversing the series order of the input data and conjugating all complex values of the data. In some examples, the zero padded frequency domain data may be the input to conjugate and flip operator 354. In some examples, conjugate and flip operator 354 may take the zero padded frequency domain data and reverse the series order of the data. In some examples, conjugate and flip operator 354 may conjugate each complex data value within the zero padded frequency domain data. To conjugate a data value may include changing the sign of each imaginary portion of each complex number (e.g., 1+1j becomes 1−1j). In some examples, reversing the series order of a frequency domain data series may represent flipping of the frequency domain signal along the frequency domain. In some examples, the output of conjugate and flip operator 354 may be sent to the input of circular convolution operator 356.

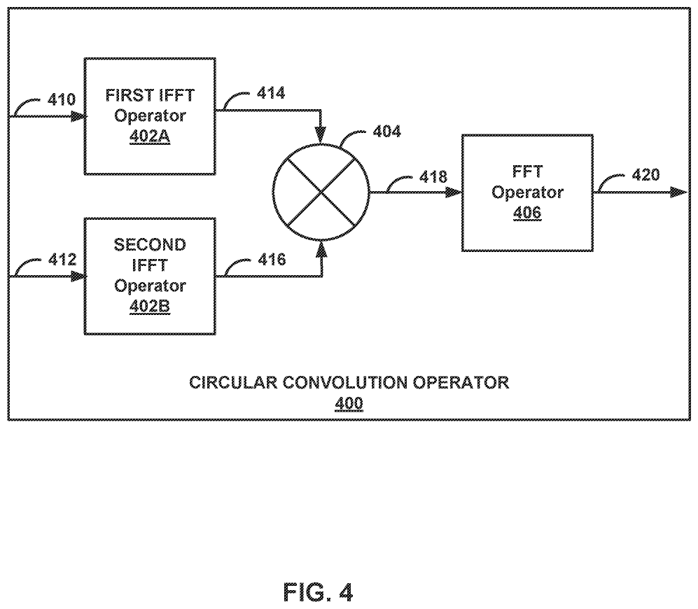

In some examples, circular convolution operator 356A, circular convolution operator 356B, and circular convolution operator 356C (collectively “circular convolution operators 356”) may perform techniques for implementing a circular convolution on imputed data. Performing circular convolution techniques may include receiving two inputs and convolving the two inputs together. In some examples, an IFFT of each input may be performed before signal multiplying the result to get a single time domain series, an example illustrated in FIG. 4 The single time domain series may be transformed into a single frequency domain signal after performing an FFT on the time domain series, an example illustrated in FIG. 4.

In some examples, a first input into each circular convolution operator of circular convolution operators 356, may be the output from a conjugate and flip operator. A second input into each circular convolution operator of circular convolution operators 356, may be the output form a zero padding operator.

In some examples, performing circular convolution operator 356 on a first compensated signal and a second compensated signal may include taking an IFFT of the first compensated signal and an IFFT of the second compensated signal. A first output from the IFFT of the first compensated signal, and the second output from the second IFFT may be multiplied together to produce a time domain output. An FFT may be run on the time domain output to produce the convolved output of the circular convolution operator 356.

In some examples, signal sum operator 360 may include adding a plurality of signals together to create a single combined signal. In some examples, each of the signals of the plurality of signals may be a frequency domain signal. Signal sum operator 360 may sum the frequency domain signals into a single combined frequency domain signal. In some examples, signal summation may be performed by adding corresponding data values across the plurality of data series representing frequency domain signals. In some examples, a first data value of a first data series (e.g., representing a first frequency domain signal) may be added to a first data value of a second data series (e.g., representing a second frequency domain signal), and further added to a first data value of a third data series (e.g., representing a third frequency domain signal) to become a first data value of the single combined data series (e.g., representing a first signal combined frequency domain signal). In some examples, a second data value of the first data series may be added to a second data value of the second data series, and further added to a second data value of the third data series to become a second data value of the single combined data series. In some examples, signal sum operator 360 may produce a summation signal being a data series representing a frequency domain signal.

In some examples, the technique for producing a time domain signal used to estimate a distance may include a insert zeros operator 362 technique. Insert zeros operator 362 may include adding zero values to the middle of an input data series. In some examples, insert zeros operator 362 may include adding zero values to the beginning and end of the input data series when performing diversity combining. In some examples, insert zeros operator 362 may include exclusively adding zero values to the beginning when diversity combining is not being performed. In some examples, the input data series may include the summation signal produced by signal sum operator 360. In some examples, insert zeros operator 362 may produce a zero corrected signal, being a data series representing a frequency domain signal with added zero values. In some examples, the zero corrected signal may be configured as an input to an IFFT operator.

FIG. 4 is a conceptual block diagram illustrating an example of signal processing techniques implemented with a circular convolution operator, in accordance with the disclosure. In some examples, performing circular convolution 400 may include receiving a first frequency domain input signal 410 and a second frequency domain input signal 412. In some examples, a first frequency domain input signal 410 may be an input to a first IFFT operator 402A. In some examples, a second frequency domain input signal 412 may be an input to a second IFFT operator 402B.

In some examples, first IFFT operator 402A and second IFFT operator 402B may both be examples of IFFT techniques. First IFFT operator 402A and second IFFT operator 402B may use multiplication and additions operations to perform an IFFT and a digital data series representing a frequency domain signal. In some examples, first frequency domain input signal 410 input to second IFFT operator 402B may be a data series output from conjugate and flip operator 354. In some examples, first frequency domain input signal 412 input to second IFFT operator 402B may be a copy of the zero padded frequency domain signal sent from zero padding operator 352. In some examples, an output of first IFFT operator 402A and an output of second IFFT operator 402B may both be time domain signals. In some examples, the output of first IFFT operator 402A may be configured as a first input 414 into signal multiplication 404. In some examples, the output of second IFFT operator 402B may be configured as a second input 416 into signal multiplication 404.

In some examples, signal multiplication 404 may take first input 414 and second input 416. In some examples, first input 414 may include a first data series and second input 416 may include a second data series. In some examples, signal multiplication 404 may produce a data series product 418 as an output. In some examples data series product 418 may be configured as an input of an FFT operator 406. In some examples data series produce 418 may a data series that represents a time domain signal.

In some examples, FFT operator 406 may implement an FFT example technique. FFT operator 406 may use multiplication and additions operations to perform an FFT on a digital data series representing a time domain signal. In some examples, data series product may be an input to FFT operator 406. In some examples, an output of FFT operator 406 may be a frequency domain data series 420, representing a frequency domain signal. Frequency domain data series 420 may be configured as an input into signal sum operator 360 of FIG. 3.

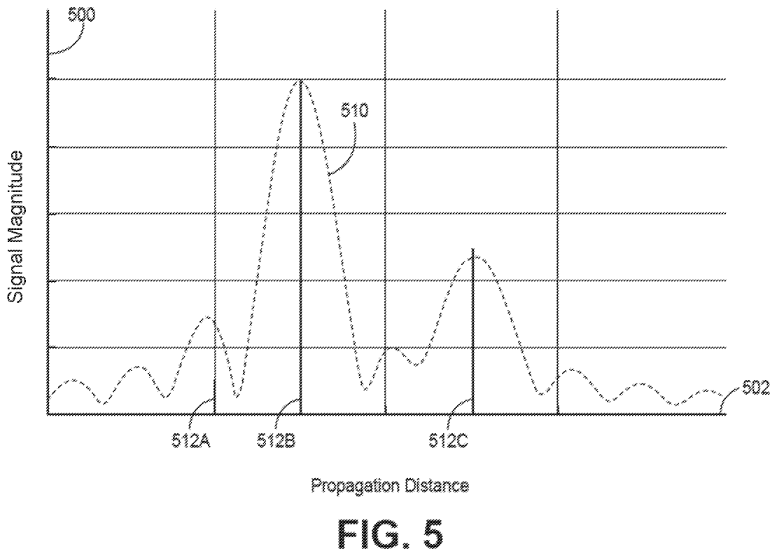

FIG. 5 is a conceptual graph illustrating a signal magnitude plot of a first frequency domain signal transformed into the time domain, in accordance with one or more techniques of this disclosure. The plot of FIG. 5 is a line chart plotted on a graph having a single abscissa axis 502 and a single ordinate axis 500. Abscissa axis 502 represents propagation distance between the transmitting device and the receiving device. The distance may correspond to a time by dividing the distance by a speed of light constant (e.g., 3.8*10\hat{«}8 meters per second). Ordinate axis 500 represents a signal magnitude of a time domain signal representation of frequency domain samples taken of the first frequency domain signal. In some examples, the first time domain signal may be an IFFT output of a sequence of samples, taken of first frequency domain signal 250A, received by first antenna 232A. In some examples, a plot of the signal magnitude of the first time domain signal may be represented as a plot of an unlimited bandwidth signal. The unlimited bandwidth time domain signal may include a first signal portion 512A, second signal portion 512B, and third signal portion 512C (collectively “signal portions 512”). In some examples, a plot of the magnitude value of the first time domain signal may also be plotted with a limited bandwidth as a first limited bandwidth time domain signal 510.

In some examples, first unlimited bandwidth time domain signal 510 may be generated by signal processor 230 using distance estimator 244 of FIG. 2. Antennas 232 may be wide bandwidth antennas configured to receive a plurality of wide bandwidth wireless signals. The antennas may transmit the plurality of wide bandwidth signals to receiver 240. Receiver 240 may be a wide bandwidth receiver, having a narrow resolution bandwidth (RBW), configured to receive the plurality of the wide bandwidth wireless signals. The bandwidth of each signal received be each antenna (e.g., first antenna 250A and second antenna 250B) may be narrower than the bandwidth of receiver 240. In some examples, the RBW of receiver 240 may be narrower than the minimum bandwidth between frequency components of the wide bandwidth wireless signals, and the wide bandwidth wireless signals may be represented by theoretical unlimited bandwidth signals.

In some examples, first unlimited bandwidth time domain signal may include a plot of signal portions corresponding to discrete distance values. Signal portions 512 may represent the first unlimited bandwidth time domain signal. In some examples, a fourth, a fifth, a sixth, etc. signal portion may be included when representing the first unlimited bandwidth time domain signal. In some examples, first signal portion 512A, second signal portion 512B, and third signal portion 512C may each represent a unique distance traveled, of a plurality of distances. Each unique distance corresponds to a distance traveled by a copy of a plurality of copies, of the signal sent to a wireless device from another wireless device. In some examples, first signal portion 512A may correspond to a shortest distance of the plurality of distances, representing the distance of line-of-sight propagation between the receiving device and the transmitting device. In some examples, vertical lines corresponding to distance values greater than the shortest distance may represent the distances traveled by a signal received by a wireless device sent by another wireless device.

In some examples, first limited bandwidth time domain signal 510 may be generated by signal processor 230 using distance estimator 244 of FIG. 2. Antennas 232 may be wide bandwidth antennas configured to receive a plurality of wide bandwidth wireless signals. The antennas may transmit the plurality of wide bandwidth signals to receiver 240. Receiver 240 may be a wide bandwidth receiver, having a narrow resolution bandwidth (RBW), configured to receive the plurality of the wide bandwidth wireless signals. The bandwidth of each signal received be each antenna (e.g., first antenna 250A and second antenna 250B) may be narrower than the bandwidth of receiver 240. In some examples, the RBW of receiver 240 may be narrower than the minimum bandwidth between frequency components of the wide bandwidth wireless signals, and the wide bandwidth wireless signals may be represented by theoretical unlimited bandwidth signals.

In some examples, first limited bandwidth time domain signal 510 may include a continuous line plot having local maximums corresponding to distances. The distances may correspond to the distances at which vertical line segments are located on the unlimited bandwidth signal. In some examples, an absolute maximum value may correspond to the shortest distance. In some examples, the absolute maximum value may correspond to a distance value greater than the shortest distance value.

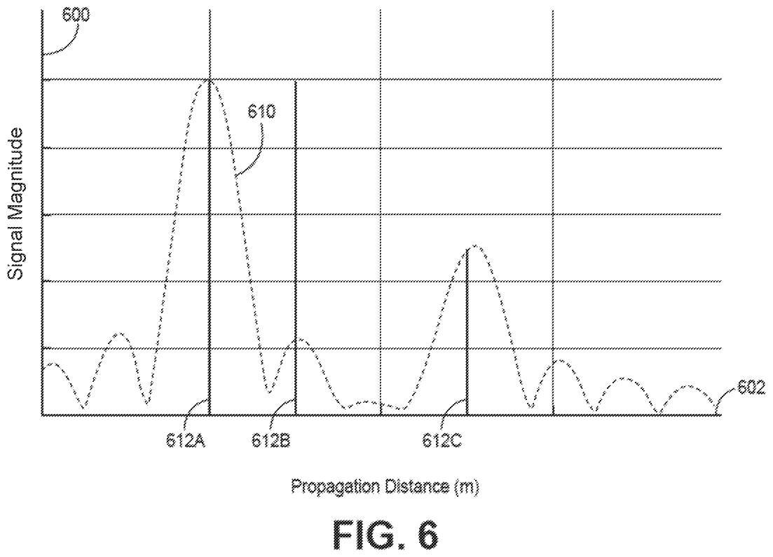

FIG. 6 is a conceptual graph illustrating a signal magnitude plot of a second frequency domain signal transformed into the time domain, in accordance with one or more techniques of this disclosure. The plot of FIG. 6 is a line chart plotted on a graph having a single abscissa axis 602 and a single ordinate axis 600. Abscissa axis 602 represents propagation distance between the wireless device and another wireless device. Ordinate axis 600 represents an amplitude of a real impedance value. In some examples, a second time domain signal may be a time domain representation of first frequency domain signal 250 received by first antenna 232. In some examples, a plot of the amplitude value of a real impedance of the first time domain signal with unlimited bandwidth may plotted as a second unlimited bandwidth time domain signal. The unlimited bandwidth time domain signal may include a first signal portion 612A, second signal portion 612B, and third signal portion 612C (collectively “signal portions 612”). In some examples, a plot of the amplitude value of a real impedance of the first time domain signal may also be plotted with a limited bandwidth as a second limited bandwidth time domain signal 610.

In some examples, second unlimited bandwidth time domain signal 610 may be generated by signal processor 230 using distance estimator 244 of FIG. 2 using similar techniques to those used to process first unlimited bandwidth time domain signal 510. In some examples, receiver 240 of FIG. 2 may include a plurality of wide bandwidth receivers. Each wide bandwidth receiver of the plurality of wide bandwidth receivers may be configured to receive a unique wideband signal. Signal portions 512 may be an unlimited bandwidth signal that models one of the wide bandwidth signals received by receiver 240.

In some examples, the plot of second unlimited bandwidth time domain signal 612 include a plot of vertical lines above discrete distance values. Each vertical line may represent the distance traveled by a signal sent to a wireless device from another wireless device. In some examples, the vertical line corresponding a shortest distance may represent the distance a line-of-sight signal traveled to the wireless device from another wireless device. In some examples, vertical lines corresponding to distance values greater than the shortest distance may represent the distances traveled by a signal received by a wireless device sent by another wireless device.

In some examples, the plot of the plot of second limited bandwidth time domain signal 610 may include a continuous line plot having local maximums corresponding to discrete distances. The discrete distances may correspond to the distances at which vertical line segments are located on the unlimited bandwidth signal. In some examples, an absolute maximum value may correspond to the shortest distance of the discrete distances. In some examples, the absolute maximum value may correspond to a distance value greater than the shortest distance value.

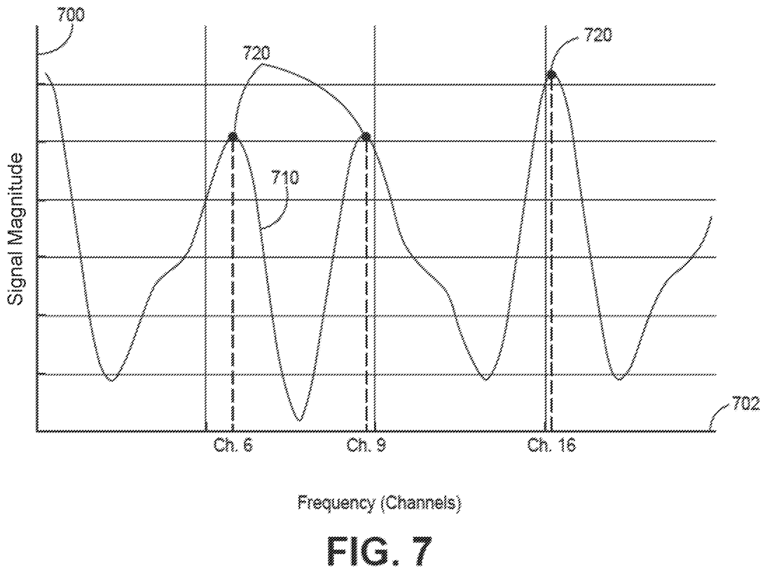

FIG. 7 is a conceptual graph illustrating a signal magnitude plot of a first frequency domain signal received by a first antenna, in accordance with one or more techniques of this disclosure. The plot of FIG. 7 is a line chart plotted on a graph having a single abscissa axis 702 and a single ordinate axis 700. Abscissa axis 702 represents frequency channels corresponding to discrete frequency sub-bands arranged sequentially in increasing frequency. Ordinate axis 700 represents a signal magnitude of a frequency domain signal generated from an FFT of a time domain signal received by the first antenna. In some examples, the plot of the signal magnitude value of the frequency domain signal may be plotted over a series of frequencies (e.g., channels) as a bandwidth limited signal.

In some examples, the plot of the amplitude value for the limited bandwidth signal may include a continuous line plot having a plurality of local maximums 720 corresponding to discrete channels (e.g., Ch. 6, Ch. 9, and Ch. 16). The plot of the limited bandwidth signal may represent an example of first frequency domain signal 250. In some examples, the limited bandwidth signal may represent an output resulting from running limited bandwidth signal of FIG. 5 through an FFT.

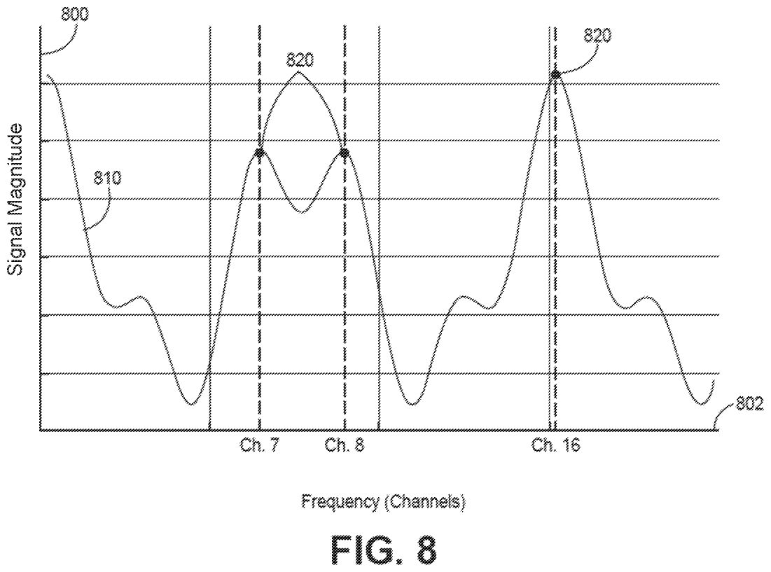

FIG. 8 is a conceptual graph illustrating a power magnitude plot of a second frequency domain signal received by a second antenna, in accordance with one or more techniques of this disclosure. The plot of FIG. 8 is a line chart plotted on a graph having a single abscissa axis 802 and a single ordinate axis 800. Abscissa axis 802 represents frequency channels corresponding to discrete frequency sub-bands arranged sequentially in in creating frequency. Ordinate axis 800 represents a signal magnitude of the second frequency domain signal. In some examples, a plot of the amplitude value of a real impedance may be plotted over channels for a bandwidth limited signal.

In some examples, the plot of the amplitude value for the limited bandwidth signal may include a continuous line plot having a plurality of local maximums 820 corresponding to discrete channels (e.g., Ch. 7, Ch. 8, and Ch. 16). The plot of the limited bandwidth signal may represent an example of second frequency domain signal 252. In some examples, the limited bandwidth signal may represent an output resulting from running limited bandwidth signal of FIG. 6 through an FFT.

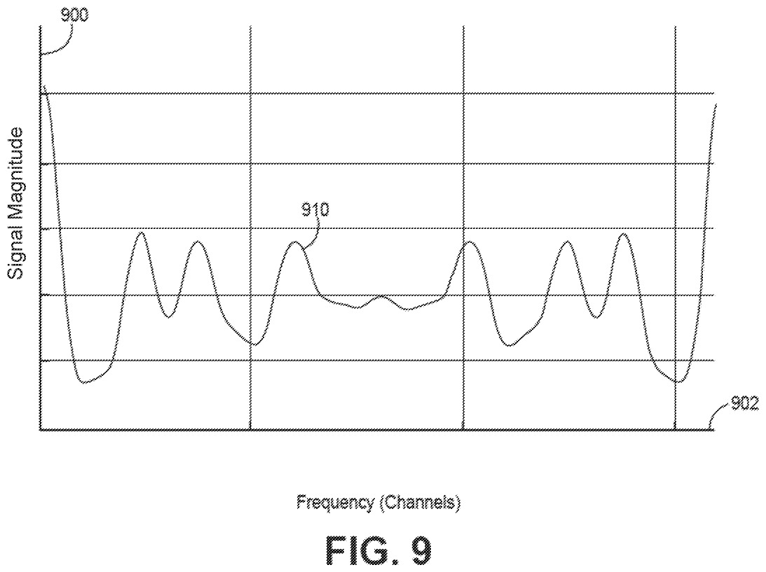

FIG. 9 is a conceptual graph illustrating a signal magnitude plot of a single combined frequency domain signal representing the combination of the first frequency domain signal and the second frequency domain signal, in accordance with one or more techniques of the disclosure. In some examples a combined frequency domain signal 910 represents the combination of first frequency domain signal 710 of FIG. 7 and the second frequency domain signal 810 of FIG. 8. In some examples first frequency domain signal may be an example of first frequency domain signal 250 of FIG. 2. In some examples first frequency domain signal may be an example of second frequency domain signal 252 of FIG. 2. The plot of FIG. 9 is a line chart plotted on a graph having a single abscissa axis 902 and a single ordinate axis 900. Abscissa axis 902 represents frequency channels corresponding to discrete frequency sub-bands arranged sequentially in in creating frequency. Ordinate axis 900 represents a signal magnitude of the combined frequency domain signal.

In some examples, combined frequency domain signal 910 may be an illustrative example of the signal represented by data series output from signal combiner 242 of FIG. 2. In some examples, combined frequency domain signal 910 may be symmetric about abscissa axis 902. In some examples, combined frequency domain signal 910 may be an illustrative example of signal represented by data series output from signal sum operator 360 of FIG. 3.

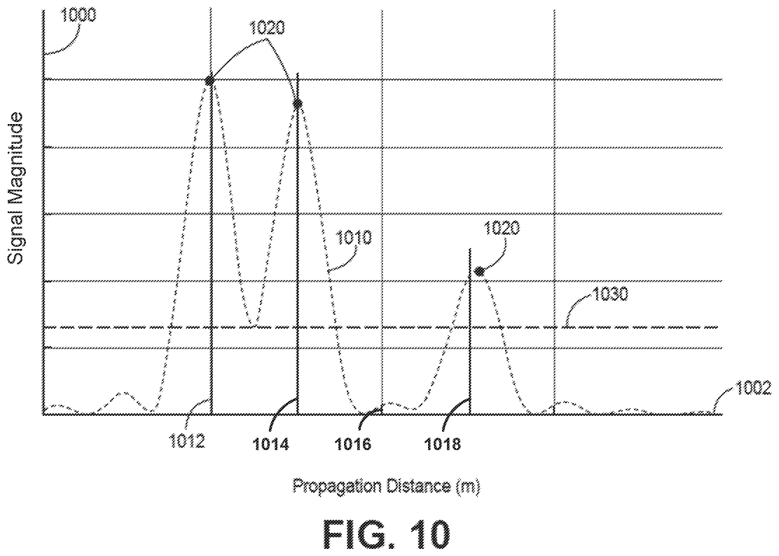

FIG. 10 is a conceptual graph illustrating a signal magnitude plot of a time domain signal representation of the single combined frequency domain signal, in accordance with one or more techniques of the disclosure. Plot of FIG. 10 is a line chart plotted on a graph having a single abscissa axis 1002 and a single ordinate axis 1000. Abscissa axis 1002 represents propagation distance between the receiving device and the transmitting device. Ordinate axis 1000 represents a signal magnitude of the combined time domain signal (e.g., signal magnitude of IFFT output). In some examples, the combined time domain signal may be represented as a combined time domain unlimited bandwidth signal 1012 and a combined time domain limited bandwidth signal 1010.

In some examples, combined time domain unlimited bandwidth signal 1012 may include a plot of vertical lines above discrete distance values. Each vertical line may represent the distance traveled by a signal sent to the receiving device from the transmitting device. In some examples, the vertical line corresponding a shortest distance may represent the distance a line-of-sight signal traveled to the receiving device from transmitting device. In some examples, vertical lines corresponding to distance values greater than the shortest distance may represent the distances traveled by a signal received by a receiving device sent by transmitting device.

In some examples, combined time domain limited bandwidth signal 1010 may include a continuous line plot having a plurality of local maximums 1020 corresponding to distances. The distances may correspond to the distances at which vertical line segments are located on the unlimited bandwidth signal. In some examples, an absolute maximum value may correspond to the shortest distance. In some examples, the absolute maximum value may correspond to a distance value greater than the shortest distance value. In some examples, plurality of local maximums 1020 may be compared to a threshold value 1030. If the value of any maximum of the plurality of local maximums 1020 is above threshold value 1030, it is compared to all other local maximums above threshold value 1030. In some examples, the local maximum of the plurality of local maximums above threshold value 1030 with the shortest associated distance, is the local maximum selected for estimating a distance. In some examples, the distance associated with the selected local maximum is used as an estimated distance. In some examples, the estimated distance associated with the selected local maximum may be an example of estimated distance 260 of FIG. 2.

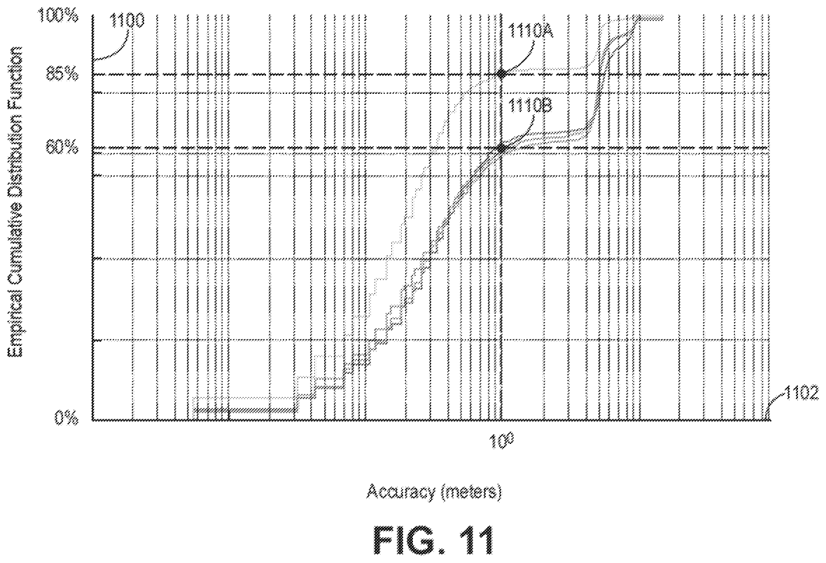

FIG. 11 is a conceptual graph illustrating the empirical cumulative distribution function (ECDF) representing signal quality for a variety of signal combination techniques with an average received signal to noise ratio (SNR), in accordance with one or more techniques of this disclosure. The techniques of exclusively using the signal from a first antenna (e.g., first antenna 232) are compared against the technique from exclusive using the signal from a second antenna (e.g., second antenna 234). The techniques of choosing a signal from either the first antenna or the second antenna according to which ever signal has a local maximum with the shortest distance (e.g., choose min), is also compared. The signal quality of the signal produced using the techniques of this disclosure is also compared to the other quality measurements. The signal quality produced by the four techniques are analyzed using a signal to noise ratio (SNR) of fifteen decibels (e.g., 15 dB). The signal quality is measured as a probability of correctly estimating the distance with an accuracy of a specified number of meters.

The plot of FIG. 11 is a line chart plotted on a graph having a single abscissa axis 1102 and a single ordinate axis 1100. Abscissa axis 1102 represents a logarithmic distance representing the accuracy (e.g., tolerance) of a particular estimate. Ordinate axis 1100 represents a probability of a particular technique generating an estimate with a given accuracy (e.g., tolerance). Ordinate axis 1100 extends from 0% up to 100%.

In some examples, the probability a device may use a signal to produce an estimated distance of less than 1 meter is represented by a point where a plot crosses the line where abscissa axis 1102 is equal to one meter (e.g., 100 meters). In some examples, the techniques for estimating a distance within one meter using signal combination techniques 1110A of this disclosure, had a 85% probability. In some examples, the techniques for estimating a distance within one meter using choose min techniques 1110B, had a 60% probability. Comparing the performance of the signal combination techniques of this disclosure to the techniques of exclusive using the signal from the first antenna or exclusively using the signal form the second antenna, results in a 15% improvement in the probability estimating a distance with an accuracy of one meter or less.

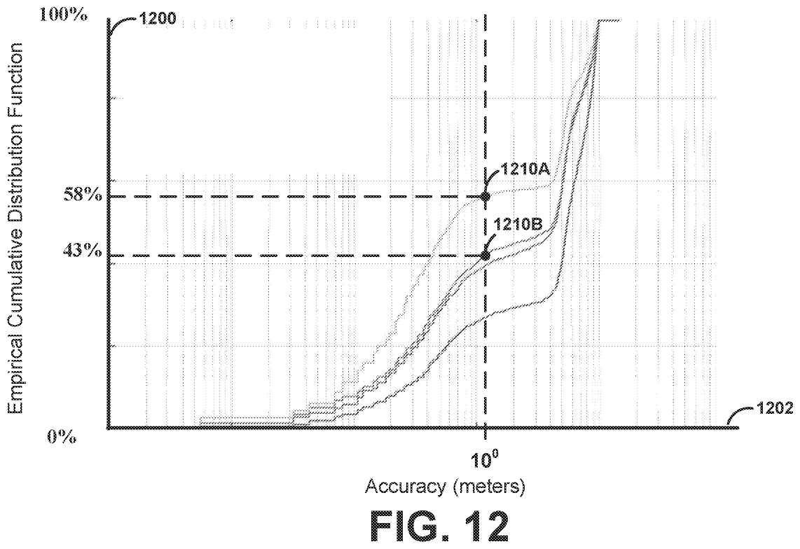

FIG. 12 is a conceptual graph illustrating the ECDF representing signal quality for a variety of signal combination techniques in the presence of low SNR signals, in accordance with one or more techniques of this disclosure. The techniques of exclusively using the signal from a first antenna (e.g., first antenna 232) are compared against the technique from exclusive using the signal from a second antenna (e.g., second antenna 234). The techniques of choosing a signal from either the first antenna or the second antenna according to which ever signal has a local maximum with the shortest distance (e.g., choose min), is also compared. The signal quality of the signal produced using the techniques of this disclosure is also compared to the other quality measurements. The signal quality produced by the four techniques are analyzed using a signal to noise ratio (SNR) of ten decibels (e.g., 10 dB). The signal quality is measured as a probability of correctly estimating the distance with an accuracy of a specified number of meters.

The plot of FIG. 12 is a line chart plotted on a graph having a single abscissa axis 1202 and a single ordinate axis 1200. Abscissa axis 1202 represents a logarithmic distance representing the accuracy (e.g., tolerance) of a particular estimate. Ordinate axis 1200 represents a probability of a particular technique generating an estimate with a given accuracy (e.g., tolerance). Ordinate axis 1200 extends from 0% up to 100%.

In some examples, the probability a device may use a signal to produce an estimated distance of less than 1 meter is represented by a point where a plot crosses the line where abscissa axis 1202 is equal to one meter (e.g., 10⁰ meters). In some examples, the techniques for estimating a distance within one meter using signal combination techniques 1210A of this disclosure, had a 58% probability. In some examples, the techniques for estimating a distance within one meter using choose min techniques 1210B, had a 43% probability. Comparing the performance of the signal combination techniques of this disclosure to the techniques of exclusive using the signal from the first antenna or exclusively using the signal form the second antenna, results in a 15% improvement in the probability estimating a distance with an accuracy of one meter or less.

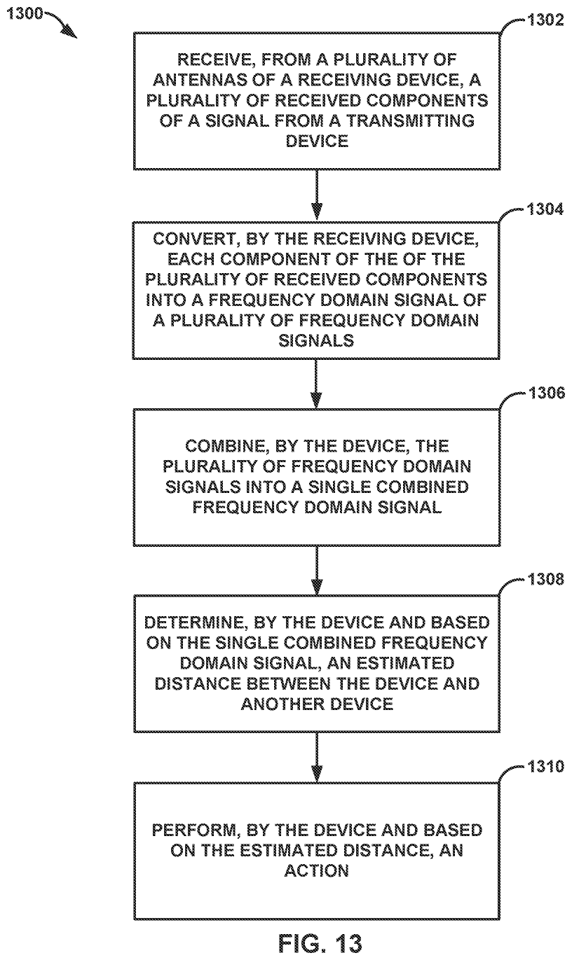

FIG. 13 is a conceptual flow chart illustrating an example of a method for estimating a distance between a receiving device and a transmitting device, in accordance with one or more techniques of the disclosure. The technique of FIG. 13 may be performed by a device, such as receiving device 102 of FIG. 1 or mobile device 202 of FIG. 2.

One or more techniques may include the receiving device configured to receive from a plurality of antennas of a device, a plurality of frequency domain signals (1302). In some examples, the plurality of antennas may include first antenna 232 and second antenna 234 of FIG. 2. In some examples, configured to receive may include configuring receiver 240 to receive first frequency domain signal 250A and second frequency domain signal 250B.

In some examples, one or more techniques may include the receiving device configured to combine, by the device, the plurality of frequency domain signals into a single combined frequency domain signal (1304). In some examples, the device may include receiving device 102. In some examples, the plurality of frequency domain signals may include first frequency domain signal 250 and second frequency domain signal 252. In some examples, the combined frequency domain signal may include single combined frequency domain signal 258. In some examples, configured to combine may include configuring signal combiner 242 to combine first frequency domain signal 250 and second frequency domain signal 252. In some examples, configured to combine may include configuring a signal processor to perform one or more techniques of FIG. 3.

In some examples, one or more techniques may include a receiving device configured to determine, by the device and based on the single combined frequency domain signal, an estimated distance between the device and another device (1306). In some examples, the device may include receiving device 102. In some examples, the combined frequency domain signal may include single combined frequency domain signal 258. In some examples the estimated distance may include estimated distance 260 generated as an output from distance estimator 244.

In some examples, one or more techniques may include a receiving device configured to perform, by the device and based on the estimated distance, an action (1308). In some examples, device may include receiving device 102. In some examples, the estimated distance may include estimated distance 260 produced by signal processor 230 via distance estimator 244. In some examples, the action may include sending, by the device to another device, a signal to electronically unlock. In some examples, the action may include reconfiguring, by having a processor combing the signals in a different manner, the device based on a signal to noise (SNR) measurement made by the device.

The following numbered examples may illustrate one or more aspects of this disclosure:

### Example 1

A method comprising: receiving, from a plurality of antennas of a receiving device, a plurality of received components of a signal from a transmitting device; converting, by the receiving device, each component of the plurality of received components into a frequency domain signal of a plurality of frequency domain signals; combining, by the receiving device, the plurality of frequency domain signals into a single combined frequency domain signal; determining, by the receiving device and based on the single combined frequency domain signal, an estimated distance between the receiving device and a transmitting device; and performing, by the receiving device and based on the estimated distance, an action.

### Example 2

The method of example 1, wherein performing the action comprises: transmitting, by the receiving device to the transmitting device, a signal to electronically unlock.

### Example 3

The method of any of examples 1 or 2, wherein combining the plurality of frequency domain signals comprises: compensating each respective frequency domain signal of the plurality of frequency domain signals with a respective compensation factor of a plurality of compensation factors to generate a plurality of compensated signals; padding, with zero padding operator, each compensated signal for the plurality of compensated signals, with zero values for a portion of time at a beginning of the signal and at an end for the signal to generate a plurality of padded signals; conjugating and flipping, with conjugate and flip operator, each padded signal of the plurality of padded signals, generating a plurality of conjugated signals; performing a circular convolution, by a circular convolution operator, on each padded signal of the plurality of padded signals with each conjugated signal of the plurality of conjugated signals, to generate a plurality of convolved compensated signals; and summing the plurality of convolved compensated signals to generate the combined frequency domain signal.

### Example 4

The method of any of examples 1-3, wherein compensating a frequency domain signal of the plurality of frequency domain signals comprises: determining, based on a calibration time delay between a first antenna and a second antenna of the plurality of antennas, the respective compensation factor for the frequency domain signal; and adjusting, based on the respective compensation factor, the frequency domain signal to generate a corresponding compensated signal of the plurality of compensated signals.

### Example 5

The method of any of examples 3-4, wherein performing a circular convolution on a compensated signal comprises: calculating, based on the compensated signal, a frequency reversed conjugate signal; inverse fast Fourier transforming, the frequency reversed conjugate signal to generate a time domain reversed conjugate signal; inverse fast Fourier transforming, the compensated signal to generate a time domain compensated signal; multiplying the time domain reversed conjugate signal and the time domain compensated signal to generate a resulting signal; and fast Fourier transforming the resulting signal to generate a corresponding convolved compensated signal of the plurality of convolved compensated signals.

### Example 6

The method of any of examples 1-5, wherein each of the plurality of frequency domain signals represents a unique signal received by an antenna of the plurality of antennas.

### Example 7

The method of any of examples 1-6, wherein determining the estimated distance between the device and the other device comprises: inverse fast Fourier transforming the combined frequency domain signal to generate a combined time domain signal; identifying a time value corresponding to a signal peak in the combined time domain signal; and calculating the estimated distance based on the time value.

### Example 8

The method of example 7, wherein identifying the time value comprises: identifying, within the combined time domain signal, one or more signal portions having amplitudes that exceed a threshold value; identifying, for each respective signal portion of the one or more signal portions, a respective peak of one or more peaks; determining, for each respective peak of the one or more peaks, a respective time value of a plurality of time values; and selecting a smallest time value of the plurality of time values as the time value.

### Example 9

The method of any of examples 1-8, wherein performing the action comprises: reconfiguring, to combine the signals in a different manner, a processor of the receiving device based on a signal to noise measurement made by the receiving device.

### Example 10

The method of any of examples 1-9, wherein the plurality of antennas comprise spatially diverse antennas.

### Example 11

A device comprising: plurality of antennas; a receiver configured to receive, via the plurality of antennas, a plurality of received components of a signal from a transmitting device; and a processor configured to convert, by the receiving device, each component of the plurality of received components into a frequency domain signal of a plurality of frequency domain signals; combine, by the receiving device, the plurality of frequency domain signals into a single combined frequency domain signal; determine, by the receiving device and based on the single combined frequency domain signal, an estimated distance between the receiving device and a transmitting device, and perform, by the receiving device and based on the estimated distance, an action.

### Example 12

The device of example 11, wherein the processor configured to perform an action comprises: a processor configured to: transmit, by the receiving device to the transmitting device, a signal to electronically unlock.

### Example 13

The device of any of examples 11 or 12, wherein the processor configured to combine the plurality of frequency domain signals comprises: further configuring the processor to compensate each respective frequency domain signal of the plurality of frequency domain signals with a respective compensation factor of a plurality of compensation factors to generate a plurality of compensated signals; pad, with zero padding operator, each compensated signal for the plurality of compensated signals, with zero values for a portion of time at a beginning of the signal and at an end for the signal to generate a plurality of padded signals; conjugate and flipping, with conjugate and flip operator, each padded signal of the plurality of padded signals, generating a plurality of conjugated signals; perform a circular convolution, by a circular convolution operator, on each padded signal of the plurality of padded signals with each conjugated signal of the plurality of conjugated signals, to generate a plurality of convolved compensated signals; and sum the plurality of convolved compensated signals to generate the combined frequency domain signal.

### Example 14

The device of any of examples 11-13, wherein the processor configured to compensate a frequency domain signal of the plurality of frequency domain signals comprises: further configured the processor to determine, based on a calibration time delay between a first antenna and a second antenna of the plurality of antennas, the respective compensation factor for the frequency domain signal; and adjust, based on the respective compensation factor, the frequency domain signal to generate a corresponding compensated signal of the plurality of compensated signals.

### Example 15

The device of any of examples 3-4, wherein the processor configured to perform a circular convolution on a compensated signal comprises: further configuring the processor to calculate, based on the compensated signal, a frequency reversed conjugate signal; inverse fast Fourier transform, the frequency reversed conjugate signal to generate a time domain reversed conjugate signal; inverse fast Fourier transform, the compensated signal to generate a time domain compensated signal; multiply the time domain reversed conjugate signal and the time domain compensated signal to generate a resulting signal; and fast Fourier transform the resulting signal to generate a corresponding convolved compensated signal of the plurality of convolved compensated signals.

### Example 16

The device of any of examples 1-5, wherein each of the plurality of frequency domain signals represents a unique signal received by an antenna of the plurality of antennas.

### Example 17

The device of any of examples 1-6, wherein the processor configured to determine the estimated distance between the device and the other device comprises: further configured the processor to inverse fast Fourier transform the combined frequency domain signal to generate a combined time domain signal; identify a time value corresponding to a signal peak in the combined time domain signal; and calculate the estimated distance based on the time value.

### Example 18

The device of example 17, wherein the processor configured to identify the time value comprises: further configured the processor to identify, within the combined time domain signal, one or more signal portions having amplitudes that exceed a threshold value; identify, for each respective signal portion of the one or more signal portions, a respective peak of one or more peaks; determine, for each respective peak of the one or more peaks, a respective time value of a plurality of time values; and select a smallest time value of the plurality of time values as the time value.

### Example 19

The device of any of examples 11-18, wherein the processor configured to perform the action comprises: the processor being further configured to reconfigure, to combine the signals in a different manner, a processor of the receiving device based on a signal to noise measurement made by the receiving device.

### Example 20

The device of any of examples 11-19, wherein the plurality of antennas comprise spatially diverse antennas.

1. A method comprising:
receiving, from a plurality of antennas of a receiving device, a plurality of received components of a signal from a transmitting device;
converting, by the receiving device, each component of the plurality of received components into a frequency domain signal of a plurality of frequency domain signals;
combining, by the receiving device, the plurality of frequency domain signals into a single combined frequency domain signal;
determining, by the receiving device and based on the single combined frequency domain signal, an estimated distance between the receiving device and the transmitting device; and
performing, by the receiving device and based on the estimated distance, an action.

2. The method of claim 1, wherein performing the action comprises:
transmitting, by the receiving device to the transmitting device, a signal to electronically unlock.

3. The method of claim 1, wherein combining the plurality of frequency domain signals comprises:
compensating each respective frequency domain signal of the plurality of frequency domain signals with a respective compensation factor of a plurality of compensation factors to generate a plurality of compensated signals;
padding, with zero padding operator, each compensated signal for the plurality of compensated signals, with zero values for a portion of time at a beginning of the signal and at an end for the signal to generate a plurality of padded signals;
conjugating and flipping, with conjugate and flip operator, each padded signal of the plurality of padded signals, generating a plurality of conjugated signals;
performing a circular convolution, by a circular convolution operator, on each padded signal of the plurality of padded signals with each conjugated signal of the plurality of conjugated signals, to generate a plurality of convolved compensated signals; and
summing the plurality of convolved compensated signals to generate the combined frequency domain signal.

4. The method of claim 3, wherein compensating a frequency domain signal of the plurality of frequency domain signals comprises:
determining, based on a calibration time delay between a first antenna and a second antenna of the plurality of antennas, the respective compensation factor for the frequency domain signal; and
adjusting, based on the respective compensation factor, the frequency domain signal to generate a corresponding compensated signal of the plurality of compensated signals.

5. The method of claim 3, wherein performing a circular convolution on a compensated signal comprises:
calculating, based on the compensated signal, a frequency reversed conjugate signal;
inverse fast Fourier transforming, the frequency reversed conjugate signal to generate a time domain reversed conjugate signal;
inverse fast Fourier transforming, the compensated signal to generate a time domain compensated signal;
multiplying the time domain reversed conjugate signal and the time domain compensated signal to generate a resulting signal; and
fast Fourier transforming the resulting signal to generate a corresponding convolved compensated signal of the plurality of convolved compensated signals.

6. The method of claim 1, wherein each of the plurality of frequency domain signals represents a unique signal received by an antenna of the plurality of antennas.

7. The method of claim 1, wherein determining the estimated distance between the device and the other device comprises:
inverse fast Fourier transforming the combined frequency domain signal to generate a combined time domain signal;
identifying a time value corresponding to a signal peak in the combined time domain signal; and
calculating the estimated distance based on the time value.

8. The method of claim 7, wherein identifying the time value comprises:
identifying, within the combined time domain signal, one or more signal portions having amplitudes that exceed a threshold value;
identifying, for each respective signal portion of the one or more signal portions, a respective peak of one or more peaks;
determining, for each respective peak of the one or more peaks, a respective time value of a plurality of time values; and
selecting a smallest time value of the plurality of time values as the time value.

9. The method of claim 1, wherein performing the action comprises:
reconfiguring, to combine the signals in a different manner, a processor of the receiving device based on a signal to noise measurement made by the receiving device.

10. The method of claim 1, wherein the plurality of antennas comprise spatially diverse antennas.

11. A device comprising:
a plurality of antennas;
a receiver configured to receive, via the plurality of antennas, a plurality of received components of a signal from a transmitting device; and
one or more processors configured to:
convert each component of the plurality of received components into a frequency domain signal of a plurality of frequency domain signals;
combine the plurality of frequency domain signals into a single combined frequency domain signal;
determine, based on the single combined frequency domain signal, an estimated distance between the device and the transmitting device; and
perform, based on the estimated distance, an action.

12. The device of claim 11, wherein, to perform the action, the one or more processors are configured to:
transmit, to the transmitting device, a signal to electronically unlock.

13. The device of claim 11, wherein, to combine the plurality of frequency domain signals, the one or more processors are configured to:
compensate each respective frequency domain signal of the plurality of frequency domain signals with a respective compensation factor of a plurality of compensation factors to generate a plurality of compensated signals;
pad each compensated signal for the plurality of compensated signals, with zero values for a portion of time at a beginning of the signal and at an end for the signal to generate a plurality of padded signals;
conjugate and flip each padded signal of the plurality of padded signals, generating a plurality of conjugated signals;
perform a circular convolution on each padded signal of the plurality of padded signals with each conjugated signal of the plurality of conjugated signals, to generate a plurality of convolved compensated signals; and
sum the plurality of convolved compensated signals to generate the combined frequency domain signal.

14. The device of claim 13, wherein, to compensate a frequency domain signal of the plurality of frequency domain signals, the one or more processors are configured to:
determine, based on a calibration time delay between a first antenna and a second antenna of the plurality of antennas, the respective compensation factor for the frequency domain signal; and
adjust, based on the respective compensation factor, the frequency domain signal to generate a corresponding compensated signal of the plurality of compensated signals.

15. The device of claim 13, wherein, to perform a circular convolution on a compensated signal, the one or more processors are configured to:
calculate, based on the compensated signal, a frequency reversed conjugate signal;
inverse fast Fourier transform, the frequency reversed conjugate signal to generate a time domain reversed conjugate signal;
inverse fast Fourier transform, the compensated signal to generate a time domain compensated signal;
multiply the time domain reversed conjugate signal and the time domain compensated signal to generate a resulting signal; and
fast Fourier transform the resulting signal to generate a corresponding convolved compensated signal of the plurality of convolved compensated signals.

16. The device of claim 11, wherein each of the plurality of frequency domain signals represents a unique signal received by an antenna of the plurality of antennas.

17. The device of claim 11, wherein, to determine the estimated distance between the device and the other device, the one or more processors are configured to:
inverse fast Fourier transform the combined frequency domain signal to generate a combined time domain signal;
identify a time value corresponding to a signal peak in the combined time domain signal; and
calculate the estimated distance based on the time value.

18. The device of claim 17, wherein, to identify the time value, the one or more processors are configured to:
identify, within the combined time domain signal, one or more signal portions having amplitudes that exceed a threshold value;
identify, for each respective signal portion of the one or more signal portions, a respective peak of one or more peaks;
determine, for each respective peak of the one or more peaks, a respective time value of a plurality of time values; and
select a smallest time value of the plurality of time values as the time value.

19. The device of claim 11, wherein, to perform the action, the one or more processors are configured to:
reconfigure, to combine the signals in a different manner, a processor of the device based on a signal to noise measurement made by the device.
